(19) United States
(12) Patent Application Publication
(10) Pub. No.: US 2002/0178443 A1
(43) Pub. Date: Nov. 28, 2002

(54) Advertisement distribution system

(76) Inventor: Tatsuya Ishii, Hyogo (JP)

Correspondence Address: MATTINGLY, STANGER & MALUR, P.C., SUITE 370, 1800 DIAGONAL ROAD, ALEXANDRIA, VA, 22314, US

(21) Appl. No.: 10/141,984

(22) Filed: May 10, 2002

(30) Foreign Application Priority Data
May 28, 2001 (JP) 2001-159243

(51) Int. Cl. H04H 9/00

(52) U.S. Cl. 725/22; 725/32

(57) ABSTRACT

It is an object of the present invention to prevent the viewer's operation to skip advertisement playback and increase the advertising effects. In order to achieve this object, the set top box temporarily stops the recording playback process and sends a command requesting advertisement distribution upon detecting the advertisement display start signal, inserted at the advertisement display start time, while playing back a recorded program broadcast from a television broadcast station. Upon receiving the command, the advertisement distribution system sends advertisement data. The set top box receives the advertisement data and plays back the data in real time. Upon detecting the advertisement display end signal inserted in the advertisement data, the set top box restarts the playback of the program.

### BACKGROUND OF THE INVENTION

1. Field of the Invention

The present invention relates to advertisement distribution technology for increasing the advertising effects of television broadcasts.

2. Description of the Related Art

In recent years, improved image quality, an increased number of channels, and an improved level of performance have become possible with the digitization of television broadcasting. Programs broadcast from broadcast stations using surface waves or sanitary waves are encoded into a digital signal using MPEG2 and multiplexed by the transport stream. It is therefore possible to record the programs received without additional processing to a large volume storage medium such as a hard disk. By recording the programs to hard disk, the viewers can record and play back programs which they want to see at a desired time.

However, broadcast programs normally include sponsor advertisements, but the viewer sometimes skips playing back the sponsor advertisements, which are unrelated to the content of the program, by fast forwarding or the like. Furthermore, technology has been proposed in Japanese Patent Laid-open Publication No. H11-127411 for skipping the advertisements in advance when the broadcast program is recorded and recording only the program.

When the viewer skips playing back advertisements when playing back the program, or skips recording the advertisements when recording the program in this way, this is inconvenient for the sponsor who does not achieve the anticipated advertising effects. When the advertisements are skipped by the viewer, the advertising effects are greatly reduced particularly in the case of television commercials, because the advertising effects are high in comparison with advertising media such as newspapers and magazines.

It is therefore an issue for the present invention to propose an advertisement distribution technology for preventing the viewer from skipping the playback of advertisements and improving advertising effects for the sponsor.

### SUMMARY OF THE INVENTION

In order to achieve the abovementioned object, the advertisement distribution system relating to the present invention receives an advertisement distribution request from a terminal device for recording and playing back programs that are broadcast from a television broadcast station, responds to the abovementioned advertisement distribution request, and distributes advertisements over a network to the abovementioned terminal device.

It is thereby possible to prevent the advertisement skipping operation by the viewer and to increase advertising effects. The advertising effects can be further improved particularly in the case of acquiring viewers individual information from the television broadcast receiver, and distributing advertisements appropriate for the viewer over a network.

A television broadcast receiver or portable terminal device are appropriate as the terminal device for recording and playing back program data.

### BRIEF DESCRIPTION OF THE DRAWINGS

FIG. 1 shows a schematic drawing of the advertisement distribution system relating to the present invention;

FIG. 2 is a drawing to explain the exchange procedures between the set top box and advertisement distribution system when a program is recorded and played back;

FIG. 3 is a drawing to explain the advertisement display process when a program is recorded and played back;

FIG. 4 is a functional block diagram of the set top box;

FIG. 5 shows a schematic drawing of the advertisement distribution network using a portable terminal device;

FIG. 6 is a drawing to illustrate a display mode of the advertisement;

FIG. 7 is a drawing to illustrate a display mode of the advertisement;

FIG. 8 is a drawing to illustrate a display mode of the advertisement;

FIG. 9 is a drawing to illustrate a display mode of the advertisement;

FIG. 10 is a drawing to illustrate a display mode of the advertisement; and

FIG. 11 is a drawing to illustrate a display mode of the advertisement.

### DESCRIPTION OF THE PREFERRED EMBODIMENTS

First Embodiment

An embodiment of the present invention is explained below with reference to the drawings.

Constitution of Set Top Box

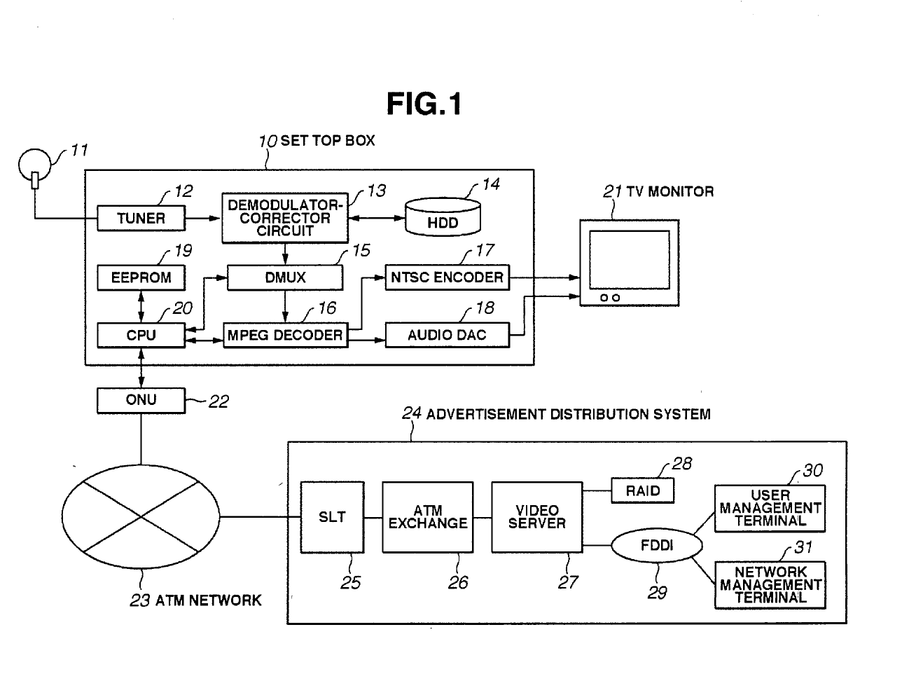

FIG. 1 shows a schematic drawing of the advertisement distribution system. In this drawing, the number 10 indicates the set top box, for receiving digital broadcasts, which is deployed in the household of a viewer. The video data and audio data, constituting a program in a digital broadcast and encoded according to MPEG2, are multiplexed in 188 byte, fixed-length transport packets. The transport packets include the following: synchronizing byte, error indicator, unit start display, transport packet priority, PID (packet ID), scramble control, adaptation field control, cycle counter, adaptation field, and payload.

The digital broadcast signal reaching the parabolic antenna 11 is converted to an intermediate frequency by the tuner 12 and then undergoes QPSK demodulation and error correction for data occurring in the transmission path by the demodulating-corrector circuit 13. A descrambling process or the like is carried out and the transport packets are reverted. When a program is recorded, the transport packets reverted with the demodulator-corrector circuit 13 are transferred and recorded to a hard disk 14. Meanwhile, when a program received from the broadcast station is viewed without being recorded or when a program recorded to the hard disk 14 is played back, the DMUX (separating portion) 15 references the PID of the transport packets and thereby separates the transport stream for one program into video and audio data. The DMUX 15 transfers the bit stream of the separated video data and audio data to the MPEG decoder 16 by direct memory access.

The MPEG decoder 16 performs a decoding process on the encoded video data and audio data. The decoded video data signal is converted to an NTSC format brightness signal, chroma signal, and composite signal with the NTSC encoder 17 and output through the buffer amp to the video terminal of the TV monitor 21. Also, the decoded audio signal is undergoes D/A conversion by the audio DAC 18 and is output through the buffer amp to the audio terminal of the TV monitor 21. The program is thereby displayed on the TV monitor 21.

Moreover, individual data for the viewer (gender, age, address, etc.) are stored in the EEPROM 19. The constitution is such that the individual data are transmitted to the advertisement distribution system 24 through the ATM network 23 when the viewer watches a program broadcast in real time or plays back a program recorded in advance to the hard disk 14. (Details are discussed below)

Constitution of the Advertisement Distribution System

Meanwhile, a video server 27 for distributing advertisements to set top boxes 10 is established in the advertisement distribution system 24. The video server 27 is installed with a network operating system, compatible with the transmission protocol, for transmitting advertisements smoothly and high speeds in response to an advertisement distribution request from a set top box 10. Also, the video server 27 contains advertisement data encoded according to MPEG2 in the RAID (disk array device) 28. In order to improve the reliability of data access, the advertisement data is interleaved and recorded to a plurality of disks in block units by the RAID 3 system. The MPEG2 transport stream recorded to the RAID 28 is mapped to the AAL5-PDU (ATM adaptation layer type 5 protocol data unit) by the video server 27 and is divided into 48 bytes. A header 5 bytes in length is then added to form a 53 byte fixed length ATM cell (MPEG over ATM).

An ATM cell transmitted from the video server 27 is placed in the ATM exchanger 26. Electrical/optical conversion appropriate for optical transmission is then carried out by the SLT (optical subscriber line terminal) 25. The ATM cell is sent over the high speed broadband transmission ATM network 23 comprising an optic fiber telecommunications network. Optical/electrical conversion is carried out with an ONU (optical line terminal device) 22 established in the subscriber's house and distributed to the set top box 10. The set top box 10 functions as an ATM terminal, reverting the received ATM cell to the MPEG2 transport stream with the CPU 20 and transferring this stream to the DMUX 15. The transport stream sent to the DMUX 15 is divided into video data and audio data and undergoes a decoding process with the MPEG decoder 16. The video signal and audio signal are then generated with the NTSC encoder 17 and audio DAC 18, and output to the TV monitor 21. Thereby, advertisements distributed from the advertisement distribution system 24 are displayed in real time as moving images on the TV monitor 21.

The video server 27 is also connected in a loop with the user management terminal 30 and network management terminal 31 through the FDDI 29 comprising a duplex optic fiber transmission path and employing the append token passing system. The user management terminal 30 accumulates individual information sent from the set top box 10 and receives the program code and sponsor code discussed below. Accordingly, the user management terminal 30 can manage the history, such as the types of programs viewed by the viewer and the viewing times. From this information, advertisements having strong advertising effects can be selected by gender and age group, or by locale. The network management terminal 31 functions as an SNMP and carries out network fault control, traffic control, and so forth.

Advertisement Distribution Procedures

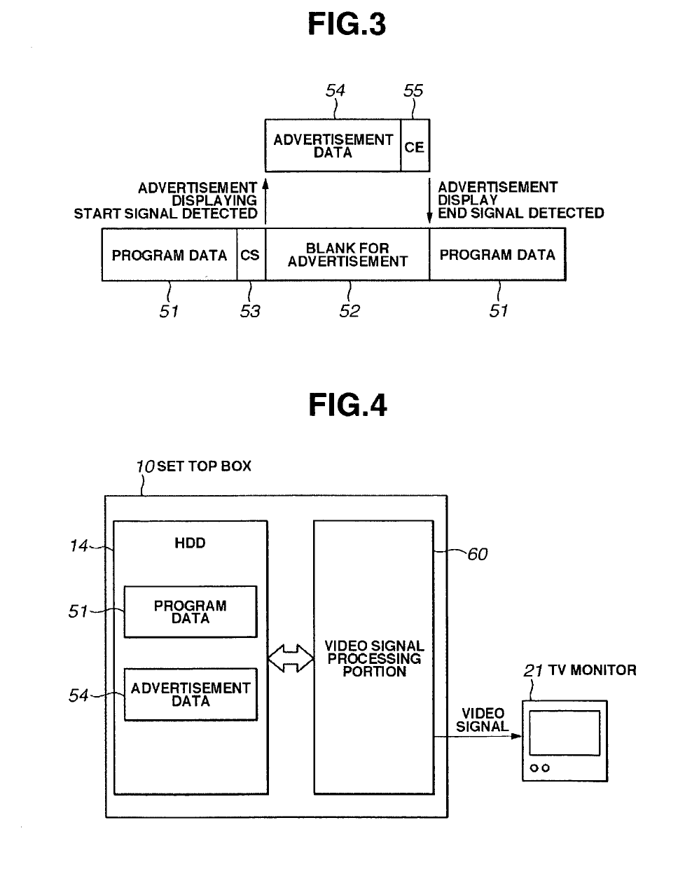

The advertisement distribution procedures are explained next. FIG. 3 is a drawing to explain the advertisement display process in the recording and playback of a program. As shown in this drawing, an advertisement blank 52 of the necessary time (for example, 60 seconds) for displaying the advertisement is established in advance in a prescribed time interval in the program data 51 broadcast from the broadcast station. An advertisement display start signal (CS) 53 showing the starting time for advertisement broadcast is attached to the header of the advertisement blank 52. Also, although not shown, the following codes are included in the program data 51: a time code showing the playback time of the program, a program code indicating the type of program, and a sponsor code specifying the sponsor.

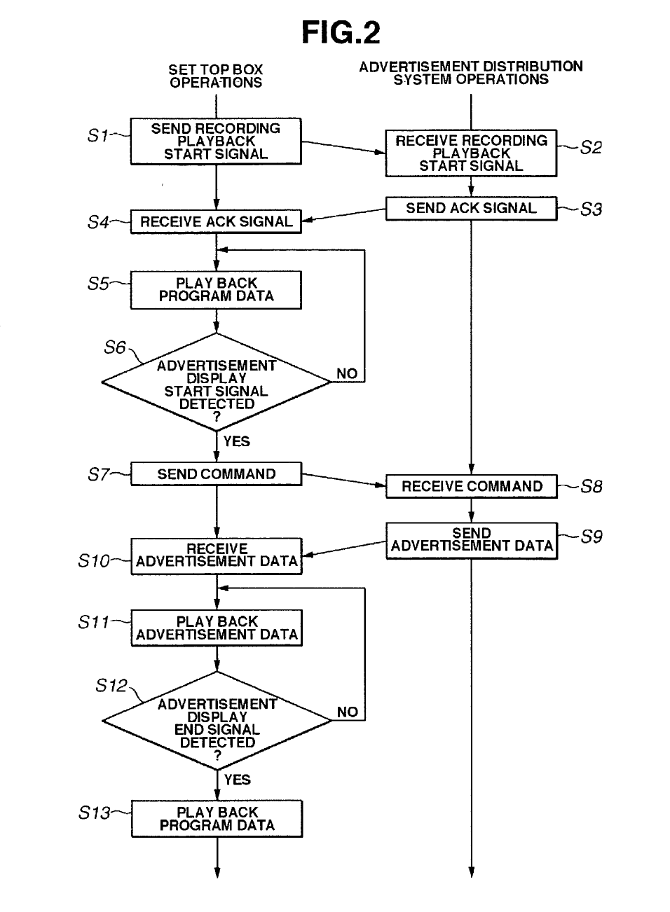

FIG. 2 is a drawing to explain the exchange procedures between the set top box 10 and the advertisement distribution system 24 when a program recorded to the hard disk 14 is played back. The set top box 10 sends a recording playback start signal to the advertisement distribution system 24 when starting to play back a program recorded to the hard disk 14 (S1). At this time, and at the same time as the transmission of the recording playback start signal, individual information of the viewer stored in EEPROM 19, and the program code and sponsor code included in the program data 51 are transmitted to the advertisement distribution system 24. Accordingly, the user management terminal 30 can learn who is watching what type of program, and when and where, from the individual information of the viewer and the program code transmitted from the set top box 10.

Upon receiving the recording playback start signal (S2), the advertisement distribution system 24 transmits an ACK signal (confirmation response signal) (S3). The ACK signal includes an advertisement message corresponding to the sponsor code. Upon receiving the confirmation signal (S4), the set top box 10 displays an advertising message on the TV monitor 21. An example of an advertising message is “This program is brought to you by XX Foods”. When the set top box 10 plays back the program data 51 (5) and detects the advertisement display start signal 53 (S6, yes), the set top box transmits a command to request advertisement distribution (S7). At this time, access to the hard disk 14 is interrupted and the recording playback process is temporarily stopped. The advertisement distribution system 24 receives the command (S8) and transmits advertisement data corresponding to the sponsor code to the set top box 10 (S9).

As shown in FIG. 3, the advertisement display end signal (CE) 55 is appended to the trailer of the advertisement data 54. Upon receiving the advertisement data 54 (S10), the set top box 10 executes the process to playback the advertisement data 54 (S11). Upon detecting the advertisement display end signal 55 (S12, yes), the set top box restarts access to the hard disk 14 and executes the recording playback process for the program data 51 (S13).

In this way, when the set top box 10 has detected the advertisement display start signal 53 during recording playback of the program, the set top box 10 automatically makes an advertisement distribution request to the advertisement distribution system 24, and plays back advertisements received from the advertisement distribution system 24 as moving images in real time. The viewer's operation to skip commercial playback can thereby be effectively prevented and the advertising effects can be improved. Also, as the program distribution source and advertisement distribution source are separate and the same program is distributed by the broadcast transmission system, the advertisement distribution system 24 is able to individually distribute advertisements appropriate for the viewer's lifestyle, preferences, and locality on the basis of the viewer's gender, age, address, program viewing time, and the like; and advertising effects can be further improved.

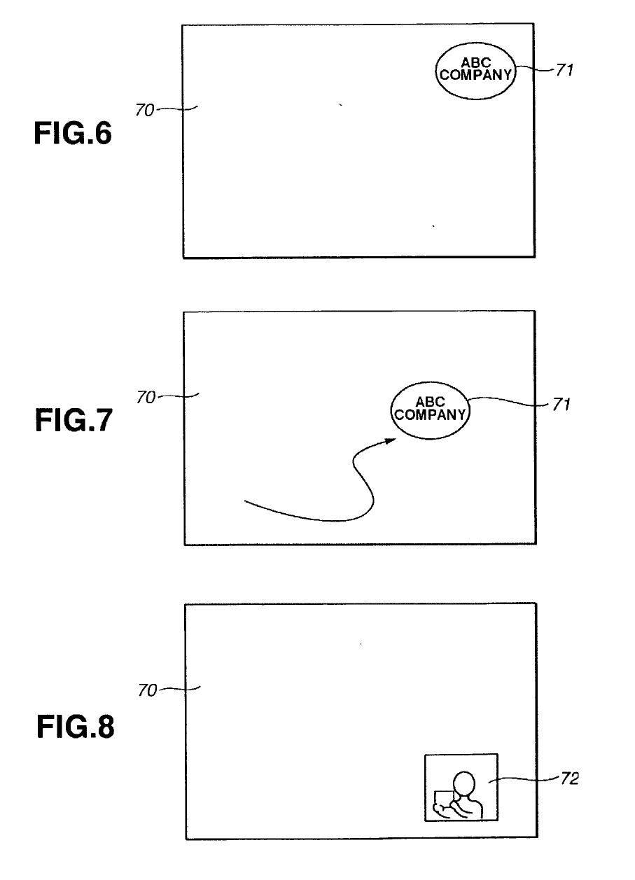

FIGS. 6 through 11 are drawings to explain the display modes for an advertisement displayed on the display screen of the television monitor 21 during fast forwarded playback of a recorded program. When the viewer fast-forwards during recording playback of the program, the set top box 10 detects the fast forwarding from the time code included the program data 51 and transmits the fast forwarding signal to the advertisement distribution system 24. Having received the fast forwarding signal, the advertisement distribution system 24 transmits advertisement data for fast forward playback to the set top box 10. An advertisement is thereby displayed on the television screen as shown in FIGS. 6 through 11 by the TV monitor 21.

FIG. 6 shows the situation wherein the trademark 71 of the program sponsored is displayed in a prescribed location on the display screen 70. There are no particular limits to the trademark 71 so long as it serves to indicate the program sponsor and can be, for example, a registered trademark, company logo, or house mark. The display location of the trademark 71 maybe a predetermined fixed position such as the upper right of the screen and the display position may be changed periodically in order to get the attention of the program viewer. Furthermore, as shown in FIG. 7, the trademark 71 may also be displayed in such manner that it moves freely about the display screen 70. FIG. 8 shows the situation wherein a moving image advertisement 72 is displayed on the display screen 70. The display position of the moving image advertisement 72 may be a predetermined fixed position such as the lower right of the screen and the display position may also be changed periodically in order to get the attention of the viewer. Furthermore, as shown in FIG. 9, the moving image advertisement 72 may also be displayed in such a manner that it moves freely about the display screen 70.

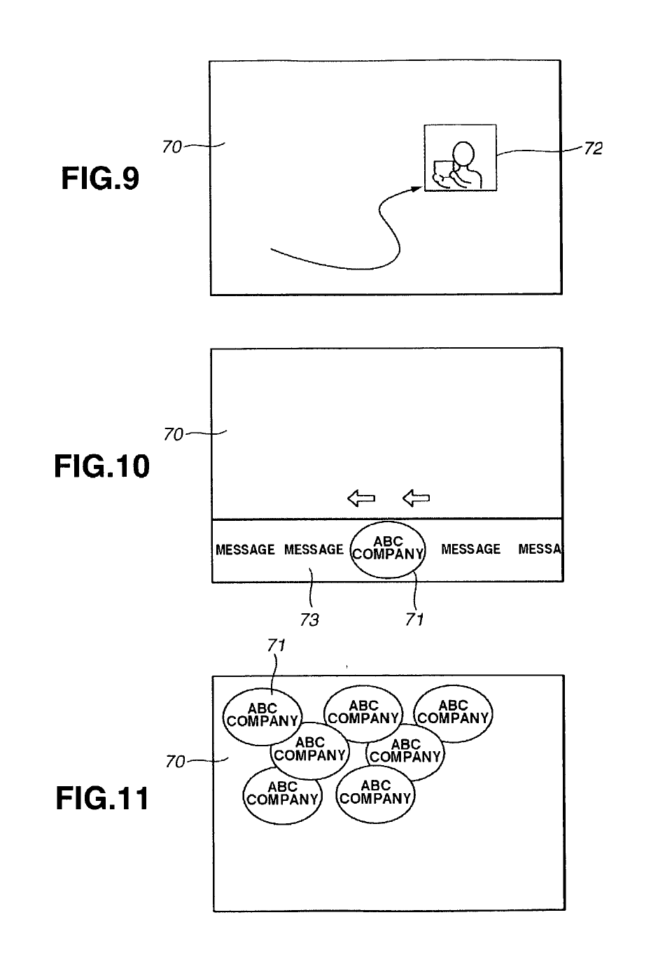

FIG. 10 shows the situation wherein the trademark 71 of the program sponsor is displayed in the lower center of the display screen 70 while the advertisement message 73 is caused to move from the right to left of the screen. The position at which the advertisement message 73 is displayed is not limited to the bottom of the screen and may also be on the top, left, or right. FIG. 11 shows the situation wherein the trademark 71 is caused to appear again and again on the display screen 70 such that the trademark 71 covers the display screen 70. The trademark 71 may be removed from the display screen 70 such that once a certain number are on the screen, they are removed one after the other.

Moreover, the above explanation concerned an example wherein a program recorded to the hard disk 14 is replayed with fast forward or the like. However, in a case of viewing a program with normal playback or viewing a program broadcast from the broadcast station in real time, normal television commercials are displayed on the full screen as in the case of normal television commercials.

Second Embodiment

The present embodiment proposes substitution means for displaying advertisements on a TV monitor in the case where the advertisement distribution system cannot be accessed because of damage to the telecommunications network or the like.

FIG. 4 shows a functional block diagram of the set top box 10. As shown in this drawing, the set top box 10 is provided a video signal processing portion 60 and hard disk 14. The video signal processing portion 60 comprises the DMUX 15, MPEG decoder 16, NTSC encoder 17, and audio DAC 18 as explained in the first embodiment. Program data 51 broadcast from the broadcast station and advertisement data 54 sent from the advertisement distribution system are stored in the hard disk 14. During recording playback of a program, the video signal processing portion 60 reads the program data 51 from the hard disk 14, converts the data to a video signal, and outputs the data to the TV monitor 21. Upon detecting the advertisement display start signal included the program data 51, the signal processing portion accesses the hard disk 14, reads advertisement data 54, converts the data to a video signal, and outputs the data to the TV monitor 21.

While the video signal processing portion 60 accesses the hard disk 14 and displays advertisements on the TV monitor 21, input operations by the viewer are made invalid and the operation to skip advertisement display is prevented. With such a constitution, even when advertisement data cannot be distributed over the network from the advertisement distribution system due to a failure of the telecommunications network or the like, advertisements can be displayed at the TV monitor 21 because of the advertisement data 54 stored to the hard disk 14 in advance.

Third Embodiment

The present embodiment proposes substitution means for displaying advertisements using a portable terminal device instead of a television broadcast receiver. The method for accessing the advertisement distribution system, the method for displaying the advertisements, and so forth are the same as in the first embodiment discussed above and a detailed explanation is therefore omitted.

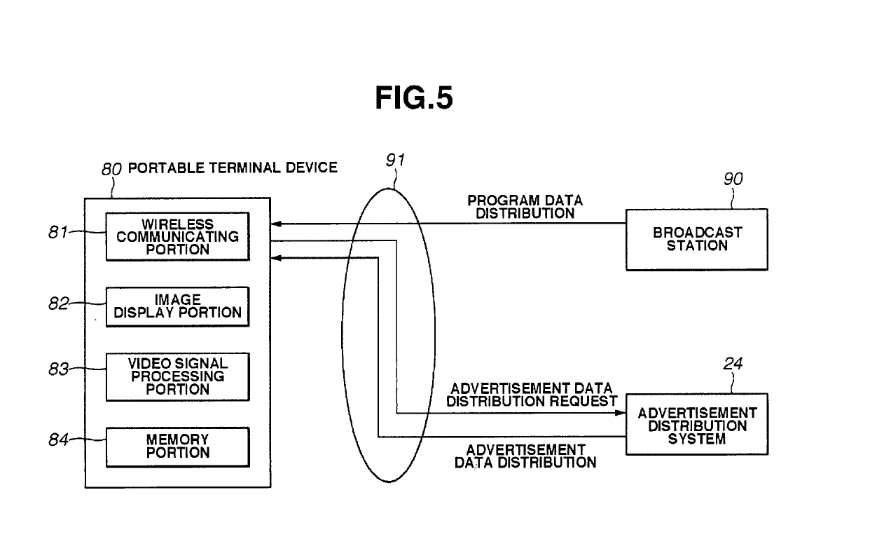

FIG. 5 shows a diagram of the system constitution of the present embodiment. The portable terminal device 80 is a terminal device which is provided wireless data communications functions such as a portable phone, personal digital assistant, electronic notepad, or palm PC, and comprises a wireless communicating portion 81, image display portion 82, video signal processing portion 83, and memory portion 84. Program data distributed from the broadcast station 90 over the wireless network 91 are stored in the memory portion 84. The video signal processing portion 83 reads program data from the memory portion 84 during recording playback of a program, generates the video signal, and displays the program on the image display portion 82. Upon detecting the advertisement display start signal included in the program data, the signal processing portion accesses the advertisement distribution system 24 and requests the distribution of advertisement data. The advertisement distribution system 24 which received the advertisement distribution request distributes advertisement data to the portable terminal device 80 through the wireless network 91. The portable terminal device 80 which received this displays the advertisement on the image display portion 82. The mode for displaying the advertisements may use any of the methods shown in FIGS. 6 through 11, for example. With the present invention, the operation for skipping advertisement display can be effectively prevented even in the case of recording playback of a program using a portable terminal device 80.

What is claimed is:

1. An advertisement distribution method comprising the steps of:
receiving an advertisement distribution request from a terminal device playing back recorded picture program data broadcast from a television broadcast station; and
responding to said advertisement distribution request and distributing advertisements to said terminal device over a network.

2. The advertisement distribution method, according to claim 1, for acquiring individual information of a viewer from said terminal device and distributing advertisements appropriate for the viewer over a network.

3. The advertisement distribution method, according to claim 1, wherein said terminal device is a television broadcast receiver.

4. The advertisement distribution method, according to claim 1, wherein said terminal device is a portable terminal device which is provided wireless data communication abilities.

5. An advertisement distribution system comprising:
means for receiving an advertisement distribution request from a terminal device playing back recorded picture program data broadcast from a television broadcast station; and
means for responding to said advertisement distribution request and distributing advertisements to said terminal device over a network.

6. The advertisement distribution system, according to claim 5, for acquiring individual information of a viewer from said terminal and distributing advertisements appropriate for the viewer over a network.

7. The advertisement distribution system, according to claim 5, wherein said terminal device is a television broadcast receiver.

8. The advertisement distribution system, according to claim 5, wherein said terminal device is a portable terminal device which is provided wireless data communication abilities.

9. A television broadcast receiver comprising:
storing means for storing program data broadcast from a television broadcast station;
program playback means for playing back program data stored in said storing means;
advertisement distribution requesting means for placing an advertisement distribution request through a telecommunications network with an advertisement distribution system upon detecting the advertisement display start signal included in said program data; and
advertisement playback means for receiving advertisement data distributed from said advertisement distribution system and playing back the advertisement data.

10. The television broadcast receiver, according to claim 9, wherein said advertisement playback means play back advertisements in the advertisement display period included in the program data.

11. The television broadcast receiver, according to claim 9, wherein said program playback means restart playing back the program data upon detecting the advertisement display end signal included in the advertisement data.

12. The television broadcast receiver, according to claim 9, wherein said storing means store advertisement data sent from said advertisement distribution system; and
said advertisement playback means read the advertisement data stored in said storing means and play back the advertisement data in the case where access to said advertisement distribution system is not possible.

13. A portable terminal device comprising:
storing means for storing program data broadcast from a television broadcast station;
program playback means for playing back program data stored in said storing means;
advertisement distribution requesting means for placing an advertisement distribution request through a telecommunications network with an advertisement distribution system upon detecting the advertisement display start signal included in said program data; and
advertisement playback means for receiving advertisement data distributed from said advertisement distribution system and playing back the advertisement data.

14. The portable terminal device, according to claim 13, wherein said advertisement playback means play back advertisements in the advertisement display period included in the program data.

15. The portable terminal device, according to claim 13, wherein said program playback means restart playing back the program data upon detecting the advertisement display end signal included in the advertisement data.

16. The portable terminal device, according to claim 13, wherein said storing means store advertisement data sent from said advertisement distribution system; and
said advertisement playback means read the advertisement data stored in said storing means and play back the advertisement data in the case where access to said advertisement distribution system is not possible.
